(19) United States
(12) Patent Application Publication
(10) Pub. No.: US 2020/0104429 A1
(43) Pub. Date: Apr. 2, 2020

(54) AUTOMATED SEARCH RESULT SORTING

(71) Applicant: salesforce.com, Inc., San Francisco, CA (US)

(72) Inventor: Keld Lundgaard, San Francisco, CA (US)

(21) Appl. No.: 16/146,707

(22) Filed: Sep. 28, 2018

(51) Int. Cl. G06F 17/30; G06F 17/11

(52) U.S. Cl. CPC G06F 17/30979; G06F 17/11; G06F 17/30991; G06F 17/30616

(57) ABSTRACT

A method of automated search result sorting includes applying a search request to a data set to generate search results, and generating a mean score value and an uncertainty value for each item in the search results by mathematically combining values of characteristics associated with the respective item, taking into account a weighting factor of the characteristic. The method further includes producing, for each of the items, a single score that is a function of the mean score value of that item and the uncertainty value of that item. This includes selecting, as the single score for each item, a value in accord with a probability distribution that is centered about the mean score value for the item and that has a standard deviation defined by the uncertainty value for that item. The method presents items from the search results ordered in accord with the respective single scores produced for them.

### BACKGROUND

The invention pertains to search optimization. It has application, by way of non-limiting example, in ranking of records retrieved as a result of application of a search term against a data set.

Searching datasets is well known. Not only is it a commonly employed on e-commerce sites, for example, to identify goods and services requested by visitor, but it is also used in academic research portals, online government repositories and, of course, on the Internet in large.

Apart from the challenges in finding items in the dataset that reasonably match users' requests, a difficulty faced in searching is ordering those items in a meaningful way for presentation to the user. In some portals, alphabetical order suffices. In others, “relevance” is the order of the day, typically, determined as a function of frequency of occurrence of the searched term within the items being presented. Still other sites order search results in accord with popularity of the returned item among the user base or a portion thereof.

E-commerce sites endeavor to take this one step further, ordering search results tuned not only to each user's demographic, but also, customized in accord with her or her browsing and purchase history. The goal is to present, first in the list of results items that the user is most likely to purchase. This can be satisfying to the user and e-commerce retailer alike.

### BRIEF DESCRIPTION OF THE DRAWINGS

A more complete understanding of the discussion that follows may be attained by reference to the drawings, in which:

FIG. 1 depicts an environment in which an embodiment is employed;

FIG. 2 depicts search functionality according to an embodiment of the type shown in FIG. 1; and

FIG. 3 depicts a method of operation of the functionality of FIG. 2.

### DETAILED DESCRIPTION OF THE ILLUSTRATED EMBODIMENT

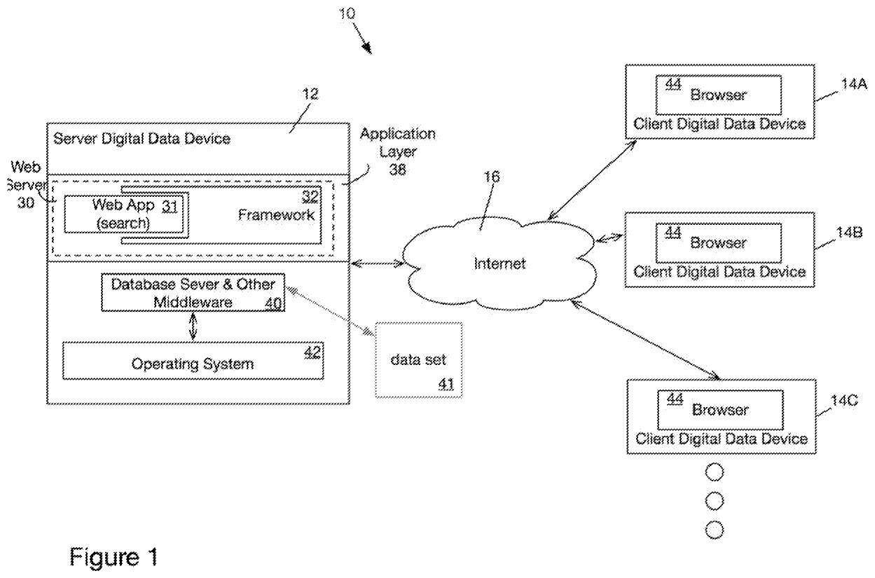

FIG. 1 depicts a digital data processing system 10 that includes a server digital data device (“server”) 12 coupled to client digital data devices (“clients”) 14A-14C via a network 16. By way of non-limiting example, illustrated server 12 hosts an e-commerce portal or platform of an online retailer and clients 14A-14C are digital devices (e.g., smart phones, desktop computers, and so forth) of users of that platform. In other embodiments, the server hosts one or more databases (e.g., of literary, governmental and/or other information) along with search engines for those databases. While, in still other embodiments, the server 12 is a search engine for the Internet, or portion thereof, or other external data sources. Both above and in the discussion that follows, the terms “search” and “recommendation” are treated as synonymous, as are “search engine” and “recommendation engine”, and the like. Also, in that discussion server 12 and the databases it searches are collectively referred to as the “platform.”

Devices 12, 14A-14C comprise conventional desktop computers, workstations, minicomputers, laptop computers, tablet computers, PDAs, mobile phones or other digital data devices of the type that are commercially available in the marketplace, all as adapted in accord with the teachings hereof. Thus, each comprises central processing, memory, and input/output subsections (not shown here) of the type known in the art and suitable for (i) executing software of the type described herein and/or known in the art (e.g., applications software, operating systems, and/or middleware, as applicable) as adapted in accord with the teachings hereof and (ii) communicating over network 16 to other devices 12, 14A-14C in the conventional manner known in the art as adapted in accord with the teachings hereof.

Examples of such software include web server 30 that executes on device 12 and that responds to requests in HTTP or other protocols from clients 14A-14C (and, more particularly, from the users thereof) for transferring web pages, downloads and other digital content to the requesting device over network 16, in the conventional manner known in the art as adapted in accord with the teachings hereof. In the illustrated embodiment, web server 30 includes web application 31 comprising search functionality of the type known in the art as adapted in accord with teachings hereof that co-operates with framework 32, e.g., to perform searches requested by users of clients 14A-14C; generates for transmission to and display on clients 14A-14C results of those searches; displays information regarding items in those results selected by, or otherwise of potential interest to, users of those clients 14A-14C; accepts purchase (or other acquisition) requests with respect to those items; and so forth, all as per convention in the art as adapted in accord with the teachings hereof.

Web application 31 of the illustrated embodiment searches data set 41 disposed locally to server 12, as shown here, remotely or otherwise. That data set, which can be a database or other store of the type known in the art as adapted in accord with the teachings hereof, may store records or other retrievable data (collectively, “items”) pertaining to e-commerce (e.g., a database of products, services or otherwise) or otherwise (e.g., a database pertaining to literary, governmental and/or other variety of information), all per convention in the art as adapted in accord with the teachings hereof. It may also store cached web pages or other information from the internet or portion thereof; though, some embodiments may forego such caching and, instead, utilize search functionality 31 to search the Internet, or portions thereof, directly, again, all per convention in the art as adapted in accord with the teachings hereof.

Web framework 32 comprises conventional such software known in the art (as adapted in accord with the teachings hereof) providing libraries and other reusable services that are (or can be) employed—e.g., via an applications program interface (API) or otherwise—by multiple and/or a variety of web applications, one of which is shown here (to wit, web application 31).

In the illustrated embodiment, web server 30 and its constituent components, web application 31 and web application framework 32, execute within an application layer 38 of the server architecture. That layer 38, which provides services and supports communications protocols in the conventional manner known in the art as adapted in accord with the teachings hereof, can be distinct from other layers in the server architecture—layers that provide services and, more generally, resources (a/k/a “server resources”) that are required by the web application 31 and/or framework 32 in order to process at least some of the requests received by server 30 from client 14.

Those other layers include, for example, a data layer (which provides services supporting interaction with a database server 40 or other middleware in the conventional manner known in the art as adapted in accord with the teachings hereof) and the server's operating system 42 (which manages the server hardware and software resources and provides common services for software executing thereon in the conventional manner known in the art as adapted in accord with the teachings hereof). Other embodiments may utilize an architecture with a greater or lesser number of layers and/or with layers providing different respective functionalities than those illustrated here.

Though described herein in the context of a web server 30, in other embodiments applications 31 and 32 may define other functionality suitable for responding to user requests, e.g., a video server, a music server, or otherwise. And, though shown and discussed here as comprising web application 31 and web framework 32, in other embodiments, the web server 30 may combine the functionality of illustrated components 31 and 32 in a single component or distribute it among still more components.

With continued reference to FIG. 1, client devices 14A-14C of the illustrated embodiment execute web browsers 44 that (typically) operate under user control to generate requests in HTTP or other protocols, e.g., to perform searches, to select items from those search, to request the purchase (or otherwise acquisition) of such items, and so forth, and to transmit those requests to web server 30 over network 14—all in the conventional manner known in the art as adapted in accord with the teachings hereof. Though referred to here as web browsers, in other embodiments applications 44 may comprise web apps or other other functionality suitable for transmitting requests to a server 30 and/or presenting content received therefrom in response to those requests, e.g., a video player application, a music player application or otherwise.

The devices 12, 14A-140 of the illustrated embodiment may be of the same type, though, more typically, they constitute a mix of devices of differing types. And, although only a single server digital data device 12 is depicted and described here, it will be appreciated that other embodiments may utilize a greater number of these devices, homogeneous, heterogeneous or otherwise, networked or otherwise, to perform the functions ascribed hereto to web server 30 and/or digital data processor 12. Likewise, although three client device 14A-14C is shown, it will be appreciated that other embodiments may utilize a greater or lesser number of those devices, homogeneous, heterogeneous or otherwise, running applications (e.g., 44) that are, themselves, as noted above, homogeneous, heterogeneous or otherwise. Moreover, one or more of devices 12, 14A-140 may be configured as and/or to provide a database system (including, for example, a multi-tenant database system) or other system or environment; and, although shown here in a client-server architecture, the devices 12, 14A-14C may be arranged to interrelate in a peer-to-peer, client-server or other protocol consistent with the teachings hereof.

Network 16 comprises one or more networks suitable for supporting communications between server 12 and client device 14A-14C. The network comprises one or more arrangements of the type known in the art, e.g., local area networks (LANs), wide area networks (WANs), metropolitan area networks (MANs), and or Internet(s). Although a client-server architecture is shown in the drawing, the teachings hereof are applicable to digital data devices coupled for communications in other network architectures.

As those skilled in the art will appreciate, the “software” referred to herein—including, by way of non-limiting example, web server 30 and its constituent components, web application 31 and web application framework 32, browser 44—comprise computer programs (i.e., sets of computer instructions) stored on transitory and non-transitory machine-readable media of the type known in the art as adapted in accord with the teachings hereof, which computer programs cause the respective digital data devices, e.g., 12, 14A-14C to perform the respective operations and functions attributed thereto herein. Such machine-readable media can include, by way of non-limiting example, hard drives, solid state drives, and so forth, coupled to the respective digital data devices 12, 14A-140 in the conventional manner known in the art as adapted in accord with the teachings hereof.

Described below is operation of the web application 31, working in cooperation with framework 32 and the other components of server 12, as well as with browser 44 and other components of client device 14, all in the conventional manner known in the art as adapted in accord with the teachings hereof. Although many of the steps described below are ascribed to web application 31 (and, by implication, to other components of server 12 working therewith in the conventional manner known in the art as adapted in accord with the teachings hereof), it is within the ken of those skilled in the art to execute some or more of those steps on browser 44 (e.g., directly and/or through operation of a software proxy or otherwise) consistent with the teachings hereof.

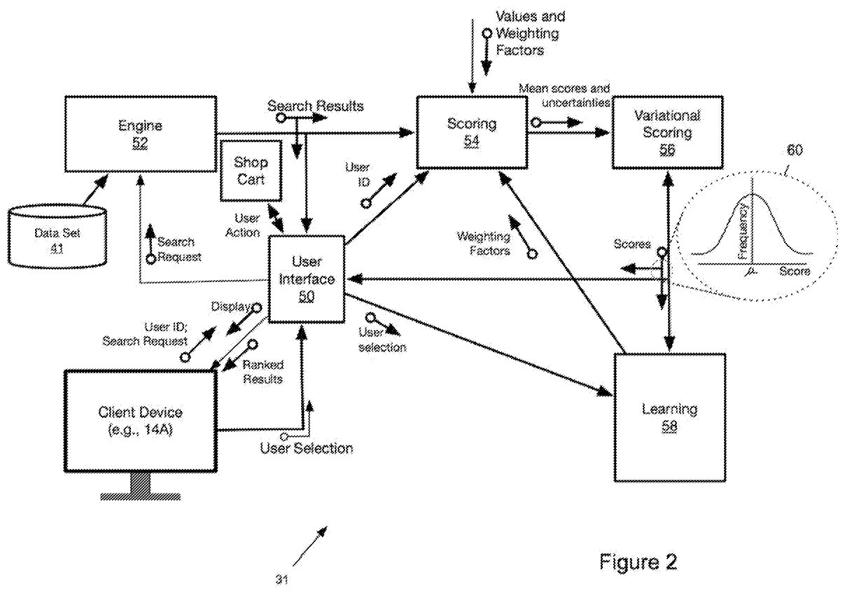

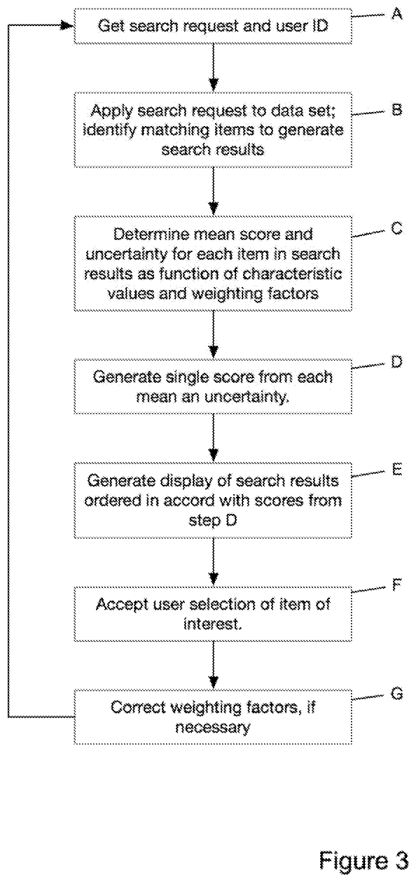

FIG. 2 depicts an architecture of web application 31 providing search functionality according to an embodiment of the type used in connection with the system of FIG. 1. Steps effected by the application 31 (or other components of system 10) during operation are shown in FIG. 3.

Referring to FIG. 2, the application 31 includes user interface 50, search engine 52, scoring module 54, variational scoring module 56, and learning module 58, each providing the respective operations described below and coupled with one another as shown for the exchange of information via function calls or otherwise, as per convention in the art as adapted in accord with the teachings hereof. Though shown and described here as part of web application 31 executing as software on server 12, one or more of the illustrated modules may execute remotely and may be invoked via remote procedure calls, remote method invocations or otherwise, as within the ken of those skilled in the art in view of the teachings hereof.

User interface 50 comprises a user interface of the type known in the art (as adapted in accord with the teachings hereof) provided by a web server, e.g., 31, in connection with the provision of search functionality to a client device, e.g., 14A, via browser 44. Thus, for example, interface 50 can transmit information in HTML or other formats for presentation on browser 44, and can receive information therefrom in accord with HTTP and other protocols. The transmitted information can include, for example, search results, whereas the received information can include, for example, search requests provided by the user and user identification information provided by the browser 44 itself or otherwise, all per convention in the art as adapted in accord with the teachings hereof.

In operation, web application 31 and more particularly, by way of example, user interface 50 drives a display to browser 44 of a client device, e.g., 14A, allowing the user thereof to make a search request. This may be by way of display of an interactive search widget, a radio button or otherwise, all per convention in the art as adapted in accord with the teachings hereof. In alternative embodiments, a search request is generated by default, e.g., as the user opens the browser 44 and/or requests a web page in connection therewith, again, as per convention in the art as adapted in accord with the teachings hereof. The browser 44 returns the search request entered by the user (or otherwise) to the user interface 50 in a conventional manner known in the art as adapted in accord with the teachings hereof. See step A (FIG. 3).

In connection with the search request, a browser session on the platform, or otherwise, the browser 44 supplies to the user interface 50 an identification of the user. This can be, e.g., by way of information supplied in “cookies” or otherwise, as per convention in the art as adapted in accord with the teachings hereof.

Engine 52 comprises a search engine of the type known in the art, as adapted in accord with the teachings hereof. In operation, it applies a search request to a data set 41 to identify items matching the request (i.e., “search results”), all per convention in the art as adapted in accord with the teachings hereof. See step B. The degree of match may be exact match, partial, fuzzy or otherwise, as per dictates of the implementation and convention in the art as adapted in accord with the teachings hereof. In the discussion that follow it is assumed that engine 52 matches and identifies multiple items from data set 41 with each search; hence, the need for ordering those items upon presentation to the user.

In the illustrated embodiment, the request is provided to the engine 52 via user interface 50, all per convention in the art as adapted in accord with the teachings hereof. In other embodiments, the request may be sourced and/or provide otherwise, all per convention in the art as adapted in accord with the teachings hereof.

Engine 52 passes the search results to scoring module 54 (for use in connection with step C) and to user interface 50 (for use in connection with step E) as an array, linked list, parameter list or otherwise, as per convention in the art as adapted in accord with the teachings hereof. The individual results may be encoded as pointers, record numbers or or other indicators from which they may be identified in the data set 41 or otherwise, again, all per convention in the art as adapted in accord with the teachings hereof.

Scoring module 54 comprises a scoring module of the type known in the art as adapted in accord with the teachings hereof. For each item in the search results received from engine 52, module 54 generates (i) a mean score value reflecting an estimated degree of desirability of the item (or a thing it represents) to the user who to whom the search results will be displayed, and (ii) an uncertainty value as to that estimate. See step C. That scoring can be based on characteristics of the item, the thing it represents, the user and/or a combination of the above.

Thus, for example, in the illustrated embodiment, scoring module 54 characterizes each item based on one or more of the following characteristics:
a characteristic of the item such as, for example, a length of time it has been in the data set 41, a source from which the item was received, and so forth;
a characteristic of the good, service or other thing (collectively, “thing”) represented by the item such as, for example, a price, color, age, size, weight, and so forth, of that thing;
a characteristic of the source of the search request and/or target for which the results of such search are intended—in both cases, typically, the user of the device (e.g., 14A) from which the search request originated and/or on which the ordered search results will be presented (collectively, “user”). Such a characteristic can be, for example, how regularly and/or recently has the user downloaded, purchased or otherwise acquired an item or thing it represents from the platform;
a characteristic of persons of like demographic as the user such as, for example, how likely a person of such demographic is to download, purchase or otherwise acquire an item or the thing represented by it from the platform;
a combined characteristic of the user and item (or the thing it represents) such as, for example, how regularly and/or recently has the user (and/or someone of like demographic) downloaded, purchased or otherwise acquired the item or thing represented by it;

all as per convention in the art as adapted in accord with the teachings hereof and all by way of non-limiting example.

Characteristics of the individual items in the search results other than those discussed above may be employed by the scoring module 54, instead or in addition, for purposes of scoring those items, all per convention in the art as adapted in accord with the teachings hereof. In the discussion that follows, the characteristics utilized in any particular embodiment are referred to below as being “associated with” that item, regardless of whether such characteristics pertain per se to the item, the thing represented by it, or the user and/or person of like demographic.

As per convention in the art, each of the characteristics associated with an item has a value—and, more particularly, in the illustrated embodiment, a numerical value. In some instances, that value may be zero or one, indicating whether or not the item is associated with that particular characteristic. In other instances, that value may take on any range of values, real, integer or otherwise, all as per convention in the art as adapted in accord with the teachings hereof.

The scoring module 54 determines the value of each associated characteristic by way of a user identification provided from the user interface 50 (or otherwise) and/or information provided in data set 41 or other store accessible to module 54. Thus, for example, the module can look-up characteristics of the item or thing it represents in the data set 41 as a function of an item identifier supplied in the search results, and it can likewise look-up characteristics of the user (or like demographic) as a function of an identifier provided with the identification supplied by the user interface 50.

The scoring module 54 generates the mean score of each individual item in the search results in a conventional manner known in the art (as adapted in accord with the teachings hereof) by summing, multiplying or otherwise mathematically combining values of the characteristics associated with the item. In making that mathematical combination, the scoring module 54 takes into account a weighting factor of each associated characteristic, e.g., multiplying (or otherwise combining) that weighting factor with the value of the respective characteristic itself before and/or otherwise in connection with mathematically combining it with the other factors (taking into account their respective weighting factors), e.g., in accord with the mathematical expression:

mean(i)=w(1)v(1)+w(2)v(2)+ . . . +w(j)v(j)

where
mean(i) is the mean score of item i;
w(i), w(2), . . . w(j) are the first, second and j^{th} weighting factors, respectively, of characteristic j associated with item i; and
v(1), v(2), . . . v(j) are the values of first, second and j^{th} characteristics, respectively, associated with item i

The foregoing expression is provided by way of example: other embodiments may utilize other mathematical expressions or techniques for determining the mean score of each item in the search results received from engine 52 in view of the values of the associated characteristics of those items and their respective weighting factors.

The scoring module 54 also determines the uncertainty, error(i), associated with the mean score, mean(i), for each item in the search results. Such uncertainty, which can result from known or estimated uncertainties associated with the values of the characteristics associated with the item, is calculated in a conventional manner known in the art (as adapted in accord with the teachings hereof) based on the specifics of the mathematical expression or combination used to calculate the mean score itself. Such calculation is within the ken of those skilled in the art in view of the teachings hereof.

As shown in FIG. 2, the scoring module passes to a variational scoring module 56, the mean scores and uncertainties for each of the items in the search results.

Variational scoring module 56 generates, for each item in the search results, a single score, s(i). See step D. The module 56 generates each such score s(i) as a function of the values of the mean and uncertainty for corresponding search result item, i, and more particularly as a value selected in accord with a probability distribution that is centered about the mean(i) and and that has a standard deviation of error(i). In the illustrated embodiment such selection is random—or, put another way, s(i) is generated as a value randomly selected in accord with the probability distribution—though other embodiments may vary in this regard. Such values can be generated using a language-specific equivalent of the Microsoft Excel function norm.inv( ) in instances where the probability distribution is a normal distribution (or, where it is not, an equivalent function appropriate to the specific distribution, i.e., a distribution-appropriate equivalent of norm.inv( )) and is otherwise within the ken of those skilled in the art in view of the teachings hereof.

In practice, each time variational scoring module 56 is invoked, it generates for each item i in the search results, a score, s(i), that is probabilistically nearer the mean score, mean(i), for that item—but that probabilistically strays from that mean in an amount dependent upon the uncertainty, error(i). If the module 56 is invoked numerous times in the course of numerous respective searches on search results that include a common item from data set 41 (i.e., an item that appears in many user-requested searches), the scores, s(i), generated for that item will vary in frequency and value in accord with the bell curve shown as element 60 of FIG. 2—thus, scores closest to the mean(i) will be generated most frequently and those further from the mean(i) less frequently, as dictated by the uncertainty error(i).

Module 56 passes the scores, s, for all of the items in the search results to the user interface 50, which receives the results themselves from the engine 52 as discussed above (though, other embodiments may vary in the particulars of the flow data between the modules).

In step E, the user interface generates, in HTML or other format, a display for transfer to, and presentation by, browser 44 of client device 14A the search results generated in step B ordered in accord with scores, s, generated in step D. In the illustrated embodiment, items with higher scores are displayed ahead of (in time and/or place) items with lower scores. This is performed in the conventional manner known in the art, as adapted in accord with the teachings hereof, and can include presenting items en masse, in batch or otherwise, and it can include generating the display to include interactive widgets (such as check boxes, and so forth) that can be used by the user to select an item of interest—again, all in a conventional manner known in the art as adapted in accord with the teachings hereof.

In step F, the user interface accepts, from browser 44 of client 14A, a user selection of a search result item of interest. This is done in a conventional manner known in the art as adapted in accord with the teachings hereof. The user interface 50 passes the user selection to a shopping cart, a selection-download function, a selection-display function, or other functionality associated with the platform for acting on the user selection, all in the conventional manner known in the art as adapted in accord with the teachings hereof. The user interface 50 also passes that selection to learning module 58.

Depending on the user selection in step F, learning module 58 generates revised weightings w(1), w(2), . . . w(j). See step G. It can pass those weightings to scoring module 54 for use in performing subsequent search results items scoring, e.g., on later searches by the same or other users.

Particularly, if the user selects, in step F, the item with the highest score, i.e., the first-most item presented in step E, the learning module 58 does not revise any weightings—since the user selection has validated at least that item's score s(i) with respect to all of the other displayed items. However, if the user selects in step F any item other than the first-most item presented in step E, it suggests that the score s(i) for that item is incorrect and so, potentially, are the weighting factors w(1), w(2), . . . w(j) used to generate the mean(i), and uncertainty, error(i) for that item (and from which s(i) was generated). In that case, for the item selected by the user in step F and each other item displayed in step E that has a higher score, the learning module generates revised weighting factors. It does this by pair-wise matching of the user-selected item and each of those other items of higher score—for each pair, performing an inverse of the score-generating calculation of step C for the items in that pair, while maintaining the characteristic values v(1), v(2), . . . v(j) as they had been during execution of step C and calculating for w(1), w(2), . . . w(j) for those characteristics that differ as between the two items. As will be appreciated by persons skilled in the art, updates to the weighting factors for the probability distribution by using non-linear optimization procedures such as stochastic gradient descent or variants thereof, where a Kullback-Leibler divergence term is added to the loss calculation that is optimized as per normal variational inference methodology, for example seen in variational auto-encoders. Thus, in some embodiments, learning module 58 generates the revised weighting factors for each pair by optimizing the expression

$$s = {f}_{a} ( p , u ) + {g}_{pb} ( r , u )$$

$${P}_{x > y} = \frac{1}{1 + exp ( - ( {s}_{x} - {s}_{y} ) )}$$

$$Loss = {a}_{x} \cdot log ( {P}_{x > y} ) + {a}_{y} \cdot log ( 1 - {P}_{x > y} ) + {D}_{KL}$$

where,
ƒₐ: Affinity, g_{pb}: Positional bias
p: Product, u: User, r: Rank a: Affinity (implied)
D_{KL}: Kullback-Leibler divergence

In such embodiments, the score, s(i), of each item in the search results is sum of a mean and error associated with each of affinity ƒₐ and a positional bias g_{pb}, expressed as follows:

s(i)=sₐ(i)+s_{pb}(i)

where
sₐ(i), is an estimate of the user's estimated affinity for the respective item (itself, determined, e.g., as a function of values of the respective item's characteristics and of user context, e.g., the user's browsing and/or purchase history), and
s_{pb}(i) is an estimate of positional bias affecting user selection (itself, determined, e.g., as a function of the order in which the respective item has been displayed, and of user context, e.g., the client device used for browsing/purchasing, the time of browsing/purchasing).
It will be appreciated that the functions for sₐ(i) and s_{pb}(i) can be of a linear or non-linear form. Specifically, use of neural networks with multiple or many layers of activations can be used, along with the usual tricks known by people skilled in the art of deep learning. Such tricks includes but are not limited to: dropout, the reparameterization trick, residual or skip connections, Rectified Linear Units (ReLU) activations, weight decay, embedding layers, sparse connections, batch normalization, pooling layers, and momentum during learning.

The learning module 58 can perform this weighting correction in connection with each user-requested search, effectively, modifying the affected weighting factors in real time, or it can perform the corrections in batch, e.g., at the end of the day, week, month, or so forth, based on user selections reflected in search query logs (that, themselves, are generated by the user interface 50 in a conventional manner known in the art as adapted in accord with the teachings hereof). And, although the illustrated embodiment does pair-wise matching of the user-selected item and each of the other items of higher score, other embodiments may do three-way or higher-order matchings, all as is within the ken of those skilled in the art in view of the teachings hereof.

Following step G, the application 31 is ready to process another search request in the manner described above, albeit with potentially new weighting factors that affect the ordering of items in presentation of results of those searches.

Described above and shown in the drawings are apparatus, systems and method for automated search results sorting. It will be appreciated that the embodiments shown here are merely examples and that others fall within the scope of the invention. Thus, by way of non-limiting example, although the discussion above refers to sorting of items returned in the search results of a search engine, the teachings are equally applicable to sorting of other types of items, regardless of how selected. By way of further non limiting example, although the discussion of steps F and G refer to user selection of only a single search result item of interest, the teachings hereof are equally applicable to the selection of multiple such items.

In view of the foregoing, what is claimed is:

1. A method of automated search result sorting, comprising
applying a search request to a data set to generate search results comprising a plurality of items matching the request;
generating a mean score value and an uncertainty value for each of the plurality of items;
producing, for each of the plurality of items, a single score that is a function of the mean score value of that item and the uncertainty value of that item;
presenting items from the search results ordered in accord with the respective single scores produced for them.

2. The method of claim 1, the producing step including selecting as the single score for each item a value in accord with a probability distribution that is centered about the mean score value for the item and that has a standard deviation defined by the uncertainty value for that item.

3. The method of claim 2, the producing step including randomly selecting the single score in accord with the probability distribution.

4. The method of claim 3, the producing step including selecting the single score using a language-specific equivalent and/or distribution-appropriate equivalent of a function norm.inv( ).

5. The method of claim 1, the generating step including
generating the mean score value for each item to reflect an estimated degree of desirability of that item, and
generating the uncertainty value for each item to reflect an uncertainty in the respective mean score value for that item.

6. The method of claim 1, the generating step including generating the mean score value for each item and the uncertainty value for each item based on characteristics of any of that item, a thing that item represents, a source of the search request and/or target for which results of the search is intended, and/or a combination thereof.

7. The method of claim 1, the generating step including generating the mean score for each item by mathematically combining values of the characteristics associated with the item.

8. The method of claim 7, the generating step including making the mathematical combination taking into account a weighting factor of the respective associated characteristic.

9. The method of claim 7, the generating step including generating the uncertainty value for each item in accord with the mathematical combination used in generating the mean score for that item.

10. The method of claim 1, wherein the applying step includes identifying items matching the request to any of an exact, partial and fuzzy degree.

11. A method of automated search result sorting, comprising
applying a search request to a data set to generate search results comprising a plurality of items matching the request;
generating a mean score value and an uncertainty value for each of the plurality of items,
the generating step including generating the mean score for each item by mathematically combining values of the characteristics associated with the item taking into account a weighting factor of the respective associated characteristic;
producing, for each of the plurality of items, a single score that is a function of the mean score value of that item and the uncertainty value of that item,
the producing step including selecting as the single score for each item a value in accord with a probability distribution that is centered about the mean score value for the item and that has a standard deviation defined by the uncertainty value for that item;
presenting items from the search results ordered in accord with the respective single scores produced for them.

12. The method of claim 11, comprising responding to selection of a presented item other than a first-most one of those items by adjusting one or more of the weighting factors.

13. The method of claim 12, the responding step including adjusting weighting factors of one or more characteristics associated with a selected item and with items presented before it.

14. The method of claim 12, comprising adjusting the weighting factors by pair-wise matching of the selected item and each of the items presented before it.

15. The method of claim 14, comprising adjusting the weighting factors by performing an inverse scoring calculation.
